(19) United States
(12) Patent Application Publication
(10) Pub. No.: US 2023/0194254 A1
(43) Pub. Date: Jun. 22, 2023

(54) WEAR AMOUNT ESTIMATION DEVICE, WEAR AMOUNT LEARNING DEVICE, AND WEAR AMOUNT MONITORING SYSTEM

(71) Applicant: Mitsubishi Electric Corporation, Tokyo (JP)

(72) Inventors: Takahiko MURAKAMI, Tokyo (JP); Hiroshi WAKAYAMA, Tokyo (JP); Shin SAKAI, Tokyo (JP); Takuma NAKAMURA, Tokyo (JP)

(73) Assignee: Mitsubishi Electric Corporation, Tokyo (JP)

(21) Appl. No.: 17/913,437

(22) PCT Filed: Dec. 25, 2020
(86) PCT No.: PCT/JP2020/048687

§ 371 Date: Sep. 22, 2022

(51) Int. Cl. G01B 21/00; B65G 43/02

(52) U.S. Cl. CPC G01B 21/00; B65G 43/02

(57) ABSTRACT

A wear amount estimation device estimates the amount of wear on mover wheels of a conveying device having a mover movable by a wheel-type guide mechanism, the mover being driven and controlled by a linear motor. The wear amount estimation device includes: a data acquisition unit that acquires, as estimation data, information on a control current flowing through the linear motor in order to drive and control the mover and information on a controlled position or speed of the driven mover; a storage unit that stores a wear amount estimation model for estimating the amount of wear; and a calculation unit that estimates the amount of wear by inputting the estimation data to the wear amount estimation model.

### FIELD

The present disclosure relates to a wear amount estimation device to estimate the amount of wear on a wheel, a wear amount learning device, and a wear amount monitoring system.

### BACKGROUND

When a wheel of a conveying device using a linear motor is worn, a relationship between a current for driving the conveying device and a thrust of the conveying device changes, which makes it difficult to accurately control the conveying device. It is therefore desirable to accurately estimate the amount of wear on the wheel of the conveying device, and on the basis of the amount of wear, to perform desired conveyance control.

A wheel wear detection device described in Patent Literature 1 measures a distance of an overhead crane in a travelling direction with laser range finders disposed on opposite lateral side ends of the overhead crane, and detects wear on wheels from a difference between measured values obtained on the opposite lateral side ends.

### CITATION LIST

### Patent Literature

Patent Literature 1: Japanese Patent Application Laid-open No. 2017-146227

### SUMMARY

### Technical Problem

Unfortunately, the technique of Patent Literature 1 suffers from a problem of complicating a device for estimating the amount of wear on the wheels as that technique requires a device of a distance measurement system in addition to a device of a traveling system.

The present disclosure has been made in view of the above, and an object thereof is to provide a wear amount estimation device with a simple configuration capable of estimating the amount of wear on a wheel.

### Solution to Problem

To solve the above problem and achieve the object, the present disclosure provides a wear amount estimation device to estimate an amount of wear on a wheel of a conveying device having a mover movable by a wheel-type guide mechanism, the mover being driven and controlled by a linear motor, the wear amount estimation device comprising a data acquisition unit to acquire, as estimation data, information on a control current flowing through the linear motor in order to drive and control the mover and information on a controlled position or speed of the driven mover. The wear amount estimation device of the present disclosure also comprises a storage unit to store a wear amount estimation model for estimating the amount of wear; and a calculation unit to estimate the amount of w-ear by inputting the estimation data to the wear amount estimation model.

### Advantageous Effects of Invention

The wear amount estimation device according to the present disclosure achieves an effect of estimating the amount of wear on the wheel with the simple configuration.

### BRIEF DESCRIPTION OF DRAWINGS

FIG. 1 is a diagram illustrating a configuration of a wear amount monitoring system including a wear amount estimation device according to an embodiment.

FIG. 2 is a diagram illustrating examples of correlations among a current flowing through a linear motor of the wear amount estimation device according to the embodiment, a thrust of the linear motor generated by the current, and the amount of wear.

FIG. 3 is a diagram illustrating an example of a relationship between a speed pattern representing a change in speed and a current flowing through the linear motor, when a mover of the wear amount estimation device according to the embodiment is driven and controlled.

FIG. 4 is a flowchart illustrating an estimation processing procedure of a wheel wear amount by the wear amount estimation device according to the embodiment.

FIG. 5 is a flowchart illustrating details of the estimation processing procedure of the wheel wear amount by the wear amount estimation device according to the embodiment.

FIG. 6 is a diagram illustrating examples of correlations between current and thrust corresponding to a plurality of amounts of wear stored in a friction amount estimation model used by the wear amount estimation device according to the embodiment.

FIG. 7 is a diagram illustrating a configuration of a wear amount monitoring system including a wear amount learning device according to the embodiment.

FIG. 8 is a flowchart illustrating a generation processing procedure of a wear amount estimation model by the wear amount learning device according to the embodiment.

FIG. 9 is a diagram illustrating a configuration of a wear amount monitoring system including the wear amount learning device and the wear amount estimation device according to the embodiment.

FIG. 10 is a diagram illustrating another configuration of a wear amount monitoring system including a wear amount learning device according to the embodiment.

FIG. 11 is a diagram illustrating a configuration of a neural network used by the wear amount learning device according to the embodiment.

FIG. 12 is a diagram illustrating an example hardware configuration that realizes the wear amount estimation device according to the embodiment.

### DESCRIPTION OF EMBODIMENTS

A wear amount estimation device, a wear amount learning device, and a wear amount monitoring system according to an embodiment of the present disclosure will be hereinafter described in detail with reference to the drawings.

### Embodiment

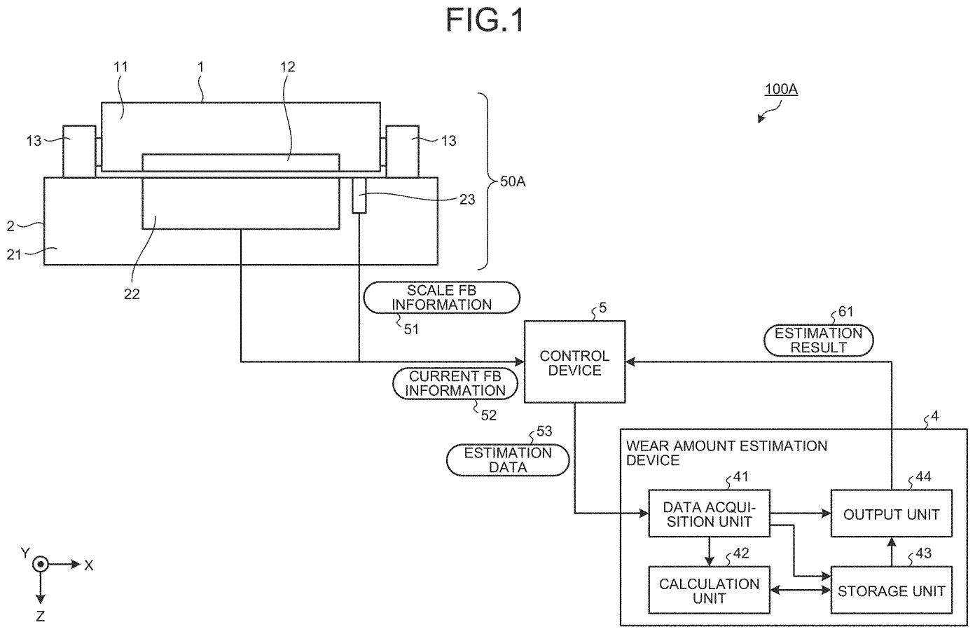

FIG. 1 is a diagram illustrating a configuration of a wear amount monitoring system including a wear amount estimation device according to an embodiment. A wear amount monitoring system 100A is a system that estimates the amount of wear on mover wheels 13 of a conveying device 50A of a linear motor-driven type. The conveying device 50A includes a wheel-type guide mechanism and is driven by a linear motor.

In FIG. 1, two axes in a plane parallel to an upper surface of the conveying device 50A, the two axes being orthogonal to each other, are defined as an X axis and a Y axis. An axis orthogonal to the X axis and the Y axis is defined as a Z axis. The Z axis is, for example, an axis parallel to the vertical direction. FIG. 1 illustrates an example where the conveying device 50A moves along a Y-axis direction, but the conveying device 50A may move in any direction.

Using information on a control current and a speed during traveling of the conveying device 50A and a wear amount estimation model, the wear amount monitoring system 100A monitors a wear state of the mover wheels 13 which are wheels of a mover 1 during traveling of the mover 1. The wear amount estimation model is a model that estimates a wheel wear amount which is the amount of wear on the mover wheels 13. The wear amount monitoring system 100A may use information on a position of the conveying device 50A instead of the information on the speed of the conveying device 50A. The wear amount monitoring system 100A may generate the information on the position of the conveying device 50A from the information on the speed thereof or may generate the information on the speed of the conveying device 50A from the information on the position thereof. The wear amount monitoring system 100A generates, from an operation program for operating the conveying device 50A, at least one of the information on the position of the conveying device 50A and the information on the speed of the conveying device 50A.

Note that the information on the control current and the information on the position or the speed in the present embodiment may be commands directed to the conveying device 50A or information used for feedback from the conveying device 50A.

The wear amount monitoring system 100A includes the conveying device 50A, a control device 5, and a wear amount estimation device 4. The conveying device 50A includes a linear motor including the mover 1 and a stator 2. The mover 1 includes a mover housing 11, a linear motor magnet 12, and a plurality of mover wheels 13. The stator 2 includes a stator housing 21, a linear motor armature 22, and a scale head 23.

The stator housing 21 is a housing of the stator 2, and the linear motor armature 22 is an armature of the linear motor. The stator housing 21 includes a wheel traveling surface. The wheel travelling surface, which is engaged with the mover wheels 13, defines a traveling route for the wheels. The scale head 23 detects information on the position of the mover 1 in a moving direction, and feeds the detected positional information back to the control device 5. That is, the scale head 23 transmits, to the control device 5, the positional information on the mover 1 to be fed back to the control device 5, as scale feedback (FB) information 51. The scale FB information 51 is represented by, for example, a Y coordinate.

The mover housing 11 is a housing of the mover 1, and the linear motor magnet 12 is a magnet of the linear motor. The mover wheels 13 are wheels of the conveying device 50A, and are attached co the mover housing 11. The mover wheels 13 guide the mover 1 movably in a thrust direction of the linear motor, and maintain a specific distance between the mover housing 11 and the stator housing 21.

The conveying device 50A carries an alternating current through the linear motor armature 22 to thereby generate a traveling magnetic field, such that an electromagnetic force generated between the travelling magnetic field and the linear motor magnet 12 moves the mover 1. The linear motor of the conveying device 50A may be a linear induction motor, or may be a linear synchronous motor.

The control device 5 is a device that controls the conveying device 50A. FIG. 1 omits illustration of an arrow from the control device 5 to the conveying device 50A. The control device 5 acquires, from the conveying device 50A, the position of the mover 1 used for feedback control of the conveying device 50A, as the scale FB information 51. The control device 5 controls the conveying device 50A on the basis of the scale FB information 51 obtained from the scale head 23, thereby causing the mover 1 to travel, in accordance with any operation pattern.

In addition, the control device 5 acquires, as current FB information 52, information on a control current used for the feedback control of the conveying device 50A from a current output to the linear motor of the conveying device 50A. The control current is information on the current which the control device 5 outputs to the linear motor of the conveying device 50A for conveyance control of the conveying device 50A. The current FB information 52 is information on a current practically used by the conveying device 50A at a time of conveyance. The current FB information 52 may be detected by a current detector installed in the conveying device 50A and acquired from the conveying device 50A, or may be detected by a current detector installed at a location in the control device 5 where the control current is output to the linear motor and acquired in the control device 5.

In that case, as the total travel distance of the mover 1 increases, wear on rolling surfaces of the mover wheels 13 progresses. As the wear on the mover wheels 13 progresses, a distance between the mover housing 11 and the stator housing 21 changes, and a distance between the linear motor magnet 12 and the linear motor armature 22 also similarly changes, so that a current-thrust characteristic of the linear motor changes. The current-thrust characteristic is a characteristic indicating a correspondence relationship between current and thrust.

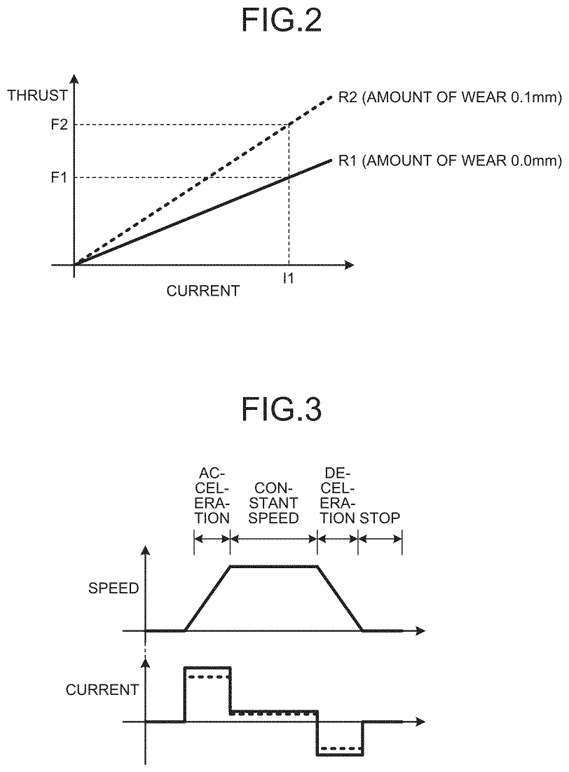

FIG. 2 is a diagram illustrating examples of correlations among a current flowing through the linear motor of the wear amount estimation device according to the embodiment, a thrust of the linear motor generated by the current, and the amount of wear.

In FIG. 2, the horizontal axis represents a current value of the current, and the vertical axis represents the thrust. When the wear progresses and the amount of wear increases, more specifically, when the distance between the linear motor magnet 12 and the linear motor armature 22 decreases, the current-thrust characteristic of the linear motor changes, such that a thrust output for the same current becomes larger than before the current-thrust characteristic of the linear motor changes, as illustrated in FIG. 2.

In FIG. 2, the current-thrust characteristic when no wear has occurred, i.e., when the amount of wear is 0.0 mm, is R1. The current-thrust characteristic when wear has occurred, for example, when the amount of wear is 0.1 mm, is R2. In a case where the current-thrust characteristic is R1, the thrust is Fl if the current value is I1, and in a case where the current thrust characteristic is R2, the thrust is F2 (>F1) if the current value is I1.

When the current-thrust characteristic is considered to provide a proportional relationship between a current and a thrust in the range of a thrust to be used, a current/thrust correlation coefficient, which is obtained by dividing the thrust by the current, can be calculated as a feature quantity representing the current-thrust characteristic. When the amount of wear on the mover wheels 13 increases, the thrust output for the same current becomes larger than before the current-thrust characteristic changes, so that the current/thrust correlation coefficient increases.

The acceleration of the mover 1 to be driven is generated by the thrust of the linear motor. As the current-thrust characteristic changes because of wear, the acceleration generated for the same current varies. Specifically, the increase in the amount of wear results in an increase in the acceleration generated for the same current.

The mover 1 is feedback-controlled by the control device 5 on the basis of the scale FB information 51 which is detected positional information, so as to provide a speed pattern with acceleration and deceleration determined by an operation program set in advance.

FIG. 3 is a diagram illustrating an example of a relationship between a speed pattern representing a change in speed and a current flowing through the linear motor, when a mover of the wear amount estimation device according to the embodiment is driven and controlled. In a graph illustrated in an upper part of FIG. 3, the horizontal axis represent time, and the vertical axis represents speed. In a graph illustrated in a lower part of FIG. 3, the horizontal axis represent time, and the vertical axis represents current. The speed and the current illustrated in FIG. 3 are a speed command and the current FB information 52, respectively.

For example, as illustrated in FIG. 3, the speed pattern includes an acceleration period, a constant speed period, a deceleration period, and a stop period. In the acceleration period, a speed is accelerated at a constant acceleration. In the constant speed period, the speed is maintained at a constant speed. In the deceleration period, toe speed is decelerated at a constant negative acceleration. In the stop period, the speed is 0, i.e., the mover 1 is at a stop. In the present embodiment, the control device 5 performs drive control to control the position of the mover 1, and generates a position command that changes in such a manner as to provide a speed pattern as illustrated in FIG. 3. The control device 5 controls the linear motor by carrying a current through the linear motor so that the scale FB information 51, which is the position of the mover 1 detected by the scale head 23, follows the position command.

The mover 1 is feedback-controlled by the control device 5 such that the mover 1 reaches a speed determined by a target speed pattern. In controlling the mover 1, the control device 5 adjusts and outputs a current such that the adjusted current flows through the linear motor so as to achieve acceleration defined as a slope of a speed in the speed pattern. In that case, when the thrust output for the same current increases because of the change in the current-thrust characteristic of the linear motor, the acceleration for the mover 1 to move in the speed pattern is obtained with a small current. As a result, a small current flows through the linear motor under the control of the control device 5.

A solid line of the current illustrated in FIG. 3 represents the current FB information 52 when the amount of wear is 0.0 mm, and a broken line of the current represents the current FB information 52 when the amount of wear is 0.1 mm. For the same acceleration during the acceleration period in the speed pattern, the value of the current FF information 52 when the amount of wear is 0.1 mm is smaller than the value of the current FF information 52 when the amount of wear is 0.0 mm.

The control device 5 transmits speed FF information based on the acquired scale FB information 51 to the wear amount estimation device 4. In addition, the control device 5 transmits the current FB information 52 as information on the control current to the wear amount estimation device 4. A drive control command, which is a command for driving and controlling the mover 1, may be a position command specifying the position of the mover 1 or a speed command specifying the speed of the mover 1. The scale FB information 51, which is feedback information corresponding to the drive control command, includes position FB information or the speed FB information. The current FB information 52 is feedback information corresponding to the control current.

As described above, the control device 5 transmits the combination of the speed FB information and the current FB, information 52 to the wear amount estimation device 4, the speed FB information being the feedback information on the speed of the mover 1, the current FB information 52 corresponding co the control current.

The wear amount estimation device 4 is a computer that estimates a wheel wear amount which is the amount of wear on the mover wheels 13. The wear amount estimation device 4 acquires estimation data 53 from the control device 5, the estimation data 53 being the current FB information 52 and the speed FB information. The current FB information 52 is information on the control current flowing through the linear motor. The speed FB information is information on the controlled speed of the driven mover 1. The estimation data 53, which is data used for estimating the wheel wear amount, is state information indicating the state of the conveying device 50A.

The wear amount estimation device 4 estimates the wheel wear amount, using the estimation data 53 and the wear amount estimation model, and stores the wheel wear amount. In addition, the wear amount estimation device 4 transmits, in response to a request from the control device 5, the wheel wear amount which is an estimation result 61 to the control device 5.

The wear amount estimation device 4 includes a data acquisition unit 41, a calculation unit 42, a storage unit 43, and an output unit 44. The data acquisition unit 41 acquires the estimation data 53 from the control device 5. The storage unit 43 is a memory, etc. that stores the wear amount estimation model.

The calculation unit 42 estimates the wheel wear amount on the basis of the estimation data 53 and the wear amount estimation model. Specifically, the calculation unit 42 inputs the estimation data 53 to the wear amount estimation model. Consequently, data output from the wear amount estimation model is the wheel wear amount as the estimation result 61. The calculation unit 42 stores the estimated wheel wear amount in the storage unit 43.

When there is a request for the wheel wear amount from the control device 5, the output unit 44 outputs the wheel wear amount stored in the storage unit 43, to the control device 5. The data acquisition unit 41 receives the request for the wheel wear amount from the control device 5 and notifies the output unit 44 of the request.

The wear amount estimation device 4 may be built in the conveying device 50A or may be configured as a device separate from the conveying device 50A as illustrated in FIG. 1. The wear amount estimation device 4 may exist on a cloud server.

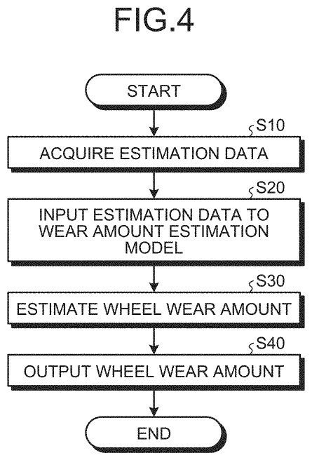

FIG. 4 is a flowchart illustrating an estimation processing procedure of a wheel wear amount by the wear amount estimation device according to the embodiment. In controlling the conveying device 50A, the control device 5 acquires, from the conveying device 50A, the speed FB information included in the scale FB information 51 and the current FB information 52. The control device 5 transmits, as information on the speed and information on the control current, the acquired speed FB information and current FB information 52 to the wear amount estimation device 4.

The data acquisition unit 41 of the wear amount estimation device 4 acquires, from the control device 5, the estimation data 53 including the speed FB information as the information on the speed and the current FB information 52 as the information on the control current (step S10).

The calculation unit 42 inputs the estimation data 53 to the wear amount estimation model (step S20). Consequently, the calculation unit 42 estimates a wheel wear amount (step S30). The wheel wear amount is stored in the storage unit 43.

When the control device 5 transmits the request for the wheel wear amount to the wear amount estimation device 4, the data acquisition unit 41 receives the request for the wheel wear amount and notifies the output unit 44 of the request. Consequently, the output unit 44 outputs the wheel wear amount stored in the storage unit 43, to the control device 5 (step 340).

Details of the estimation processing procedure of the wheel wear amount by a friction amount estimation model used by the wear amount estimation device 4 will be described. The friction amount estimation model used by the wear amount estimation device 4 is a model that stores and holds correlations between current and thrust, the correlations corresponding to a plurality of amounts of wear. The current FB information 52 and the speed FB information are input to the friction amount estimation model. The friction amount estimation model calculates acceleration on the basis of the speed FB information, further calculates a thrust from the acceleration, and calculates a detection value of a correlation coefficient between current and thrust from the current FB information 52 and the calculated thrust. The friction amount estimation model estimates the amount of wear from the detection value of the correlation coefficient and the stored correlation coefficient between current and thrust, the correlation coefficient corresponding to the wear amount.

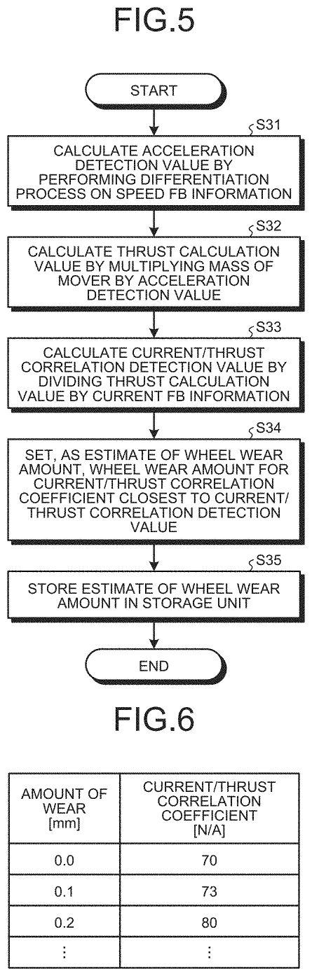

FIG. 5 is a flowchart illustrating details of the estimation processing procedure of the wheel wear amount by the wear amount estimation device according to the embodiment.

The calculation unit 42 calculates an acceleration detection value which is a detection value of acceleration by performing a differentiation process on the speed FB information acquired as the estimation data 53 (step S31).

The calculation unit 42 calculates a thrust calculation value which is a calculation value of the thrust output from the linear motor by multiply the acceleration detection value with the mass of the mover 1 stored in advance in the storage unit 43 (step S32).

The calculation unit 42 calculates a current/thrust correlation detection value by dividing the thrust calculation value by the current FB information 52 acquired as the estimation data 53 (step S33).

The calculation unit 42 determines an estimate of the wheel wear amount from the calculated current/thrust correlation detection value and the current/thrust correlation coefficients corresponding to the plurality of amounts of wear stored in advance in the storage unit 43. Specifically, the calculation unit 42 sets, as an estimate of the wheel wear amount, a wheel wear amount for a current/thrust correlation coefficient closest to the calculated current/thrust correlation detection value (step S34). The estimate of the wheel wear amount is stored in the storage unit 43 (step S35).

FIG. 6 is a diagram illustrating examples of correlations between current and thrust corresponding to the plurality of amounts of wear stored in the friction amount estimation model used by the wear amount estimation device according to the embodiment. The correlation between current and thrust is a current/thrust correlation coefficient, and information having the current/thrust correlation coefficient and the amount of wear associated with each other is stored in the friction amount estimation model.

The present embodiment has described the example in which the control device 5 transmits the current FB information 52 as the information on the control current to the wear amount estimation device 4, but the control device 5 may transmit current command information as the information on the control current. That is, the current to flow through the linear motor is controlled such that the current command information and the current FB information 52 are substantially the same. For this reason, the control device 5 may transmit the current command information as the information on the control current to the wear amount estimation device 4.

Although the control device 5 has been described as transmitting the speed FB information to the wear amount estimation device 4, the control device 5 maw transmit speed command information instead of the speed FB information to the wear amount estimation device 4. That is, the speed of the linear motor is controlled such that the speed command information and the speed FB information are substantially the same. For this reason, the control device 5 may transmit the speed command information to the wear amount estimation device 4. In that case, the calculation unit 42 of the wear amount estimation device 4 calculates the acceleration by performing a differentiation process on the speed command information. Alternatively, the control device 5 may transmit position command information or the position FB information (scale FB information 51) to the wear amount estimation device 4, and the calculation unit 42 of the wear amount estimation device 4 may calculate the acceleration by performing a differentiation process on the position command information or the position FB information twice. The position PB information is positional information on the mover 1 to be fed back to the control device 5.

In addition, the present embodiment has described the example in which the correlation between current and thrust is a proportional relationship and the current/thrust correlation coefficients are stored, but data other than the current/thrust correlation coefficients may be stored. For example, the storage unit 43 may store graphs of the correlations between constant ranges or sections of current values and constant ranges or sections of thrust values, the correlations corresponding co the plurality of amounts of wear. In that case, the calculation unit 42 estimates the amount of wear, searching for a graph of correlation between the section of current values and the section of thrust values, the correlation being closest to the relationship between the current FB information 52 and the thrust in the conveying device 50A.

The current-thrust characteristic changes when a change in a coil temperature in the linear motor is large. The generation of heat caused by the flow of current through the linear motor and the dissipation of heat from the linear motor are balanced with each other to allow the coil temperature converges to an average temperature, the average temperature varying depending on, for example, a frequency of operating the linear motor in the speed pattern. The data acquisition unit 11 may therefore acquire the coil temperature which is a temperature of the coil of the linear motor. In that case, the calculation unit 42 calls, on the basis of the acquired coil temperature, a correction coefficient close to the acquired coil temperature from a plurality of correction coefficients corresponding to a plurality of coil temperatures stored in the storage unit 43 in advance. Then, the calculation unit 42 multiplies data on the information on the control current, data on the information on the position or the speed, or data on the acceleration calculated from the information on the position or the speed, by the correction coefficient to thereby correct That data, and estimates the amount of wear. By correcting the data used for estimating the amount of wear with the correction coefficient corresponding to the coil temperature, the calculation unit 42 can estimate the wheel wear amount more accurately than when the calculation unit 42 estimates the wheel wear amount without the correction.

There is another correction method regarding the coil temperature. Since heat generated by a current flowing through the linear motor is generated in proportion to the square of the current, an effective load factor obtained by squaring acquired information on the current and averaging the squared information with a thermal time constant is an indicator of a temperature of the linear motor. For this reason, the calculation unit 42 may calculate the effective load factor by squaring the acquired information on the current and passing the squared information through a first-order lag filter that performs averaging with a thermal time constant. In that case, the calculation unit 42 corrects the current-thrust characteristic, for example, by calling a current-thrust characteristic close to the calculated effective load factor, from the storage unit 43 that in advance stores a plurality of current-thrust characteristics corresponding to a plurality of effective load factors and using the current-thrust characteristic. With such a simple configuration that does not require acquiring the coil temperature through a sensor or the like during the operation of the wear amount estimation device 4, consequently, the wear amount estimation device 4 can estimate the wheel wear amount more accurately than when the wear amount estimation device 4 estimates the wheel wear amount without the correction.

In a case where the change in the coil temperature is small or in a case where the change in the current-thrust characteristic because of the change in the coil temperature is consider small, the calculation unit 42 may not perform the correction using the coil temperature.

A method of measuring the amount of wear on mover wheels of a conveying device includes a method involving providing the conveying device with a measurement system of the amount of wear on the mover wheels. Since this method requires the measurement system or the amount of wear on the mover wheels, a configuration of a measurement device is complicated. In addition, a highly accurate measurement system is required to detect a minute amount of wear, which makes the conveying device expensive. The wear amount learning device of the present embodiment uses the wear amount estimation model, thereby making it possible to estimate a minute amount of wear with the wear amount estimation device 4 of a simple configuration without making the conveying device 50A expensive.

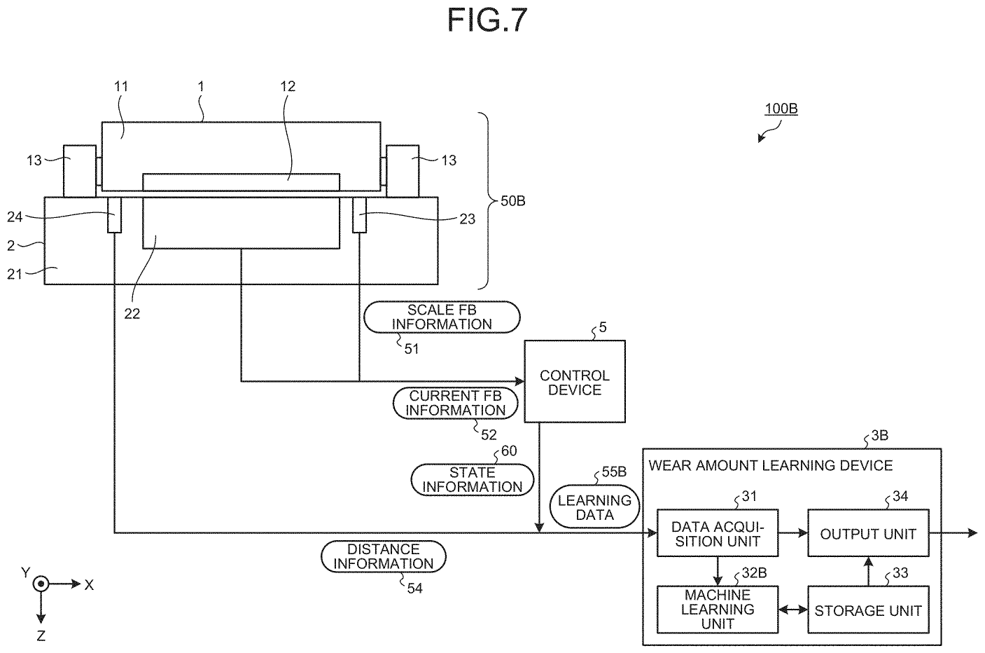

Next, a generation process of the wear amount estimation model will be described FIG. 7 is a diagram illustrating a configuration of a wear amount monitoring system including a wear amount learning device according to the embodiment. Regarding components among components in FIG. 7 that achieve the same functions as those of the wear amount monitoring system 100A illustrated in FIG. 1, the same reference signs are assigned thereto, and repetitive descriptions thereof will be omitted.

A wear amount monitoring system 100B is a system that machine-learns a wheel wear amount and generates a wear amount estimation model used for estimating the wheel wear amount. A conveying device 50B is a device similar to the conveying device 50A.

In FIG. 7, two axes in a plane parallel to an upper surface of the conveying device 50B, the two axes being orthogonal to each other, are defined as an X axis and a Y axis. An axis orthogonal to the X axis and the Y axis is defined as a Z axis, The Z axis is, for example, an axis parallel to the vertical direction. FIG, 7 illustrates an example where the conveying device 50B moves along a Y-axis direction, but the conveying device 50B may move in any direction.

The wear amount monitoring system 100B includes the conveying device 50B, the control device 5, and a wear amount learning device 3B. The conveying device 50B includes at least one distance sensor 24 in addition to the components of the conveying device 50A. The distance sensor 24 is disposed on the stator 2. The control device 5 included in the wear amount monitoring system 100B may be a device different from the control device 5 of the wear amount monitoring system 100A.

The distance sensor 24 is a sensor that detects a distance between the mover 1 and the stator 2. The distance sensor 24 transmits the detected distance as distance information 54 to the wear amount learning device 3B. The distance information 54 is information corresponding to the wheel wear amount.

The control device 5 acquires, from the conveying device 50B, the position FB information, the speed FB information, and the current PB information 52. The position FB information and the speed FB information are Pieces of information included in the scale FB information 51. The control device 5 transmits information on the position of the mover and information on the speed of the mover to the wear amount learning device 3B. Specifically, the control device 5 transmits, to the wear amount learning device 3B, the acquired position PB information, the acquired speed FB information, position command information which is information on a command of the position of the mover 1, and speed command information which is a derivative of the position command information. In addition, the control device 5 transmits the current FB information 52 to the wear amount learning device 3B. The current PB information 52 is information on the control current.

As described above, the control device 5 transmits, to the wear amount learning device 3B, the combination of: the position command information and the speed command information; the position FB information and the speed FB information both or which are obtained from the scale FB information 51; and the current FB information 52 obtained from the detected control current flowing through the linear motor.

The wear amount learning device 3B is a computer that generates a wear amount estimation model for estimating a wheel wear amount which is the amount of wear on the mover wheels 13. The wear amount learning device 3B acquires, from the control device 5, the current FB information 52 which is information on the control current, and the position command information, the speed command information, the position FB information, and the speed FB information which are pieces of information on the position and the speed of the mover 1. The current FB information 52, the position command information, the speed command information, the position FB information, and the speed FB information are defined as state information 60 indicating the state of the conveying device 50B.

In addition, the wear amount learning device 3B acquires the distance information 54 from the conveying device 50B. The distance information 54 is defined as teaching data. That is, the wear amount learning device 3B acquires learning data 55B including the state information 60 and the distance information 54, from the control device 5 and the conveying device 50B. The learning data 55B is data used for generating the wear amount estimation model.

The wear amount learning device 31 learns the wheel wear amount, using the learning data 551 and generates the wear amount estimation model. The wear amount learning device 31 generates the wear amount estimation model that can calculate an accurate wheel wear amount. The wear amount learning device 31 stores the wheel wear amount and transmits the wear amount estimation model to the wear amount estimation device 4 in response to a request of the wear amount estimation device 4.

The wear amount learning device 3B includes a data acquisition unit 31, a machine learning unit 32B, a storage unit 33, and an output unit 34. The data acquisition unit 31 acquires the state information 60 from the control device 5 and acquires the distance information 54 from the conveying device 50B. That is, the data acquisition unit 31 acquires the state information 60 and the distance information 54 corresponding to the state information 60. The state information 60 and the distance information 54 are defined as the learning data 55B.

The machine learning unit 32B generates a wear amount estimation model on the basis of the learning data 55B. Specifically, the machine learning unit 321 acquires, from the data acquisition unit 31, the learning data 55B which is a dataset created by combining the state information 60 and the distance information 54, and learns the wheel wear amount on the basis of the learning data 55B. A method of machine-learning of the wheel wear amount: will be described later. The wear amount learning device 3B stores, in the storage unit 33, the wear amount estimation model obtained as a result of the machine learning.

The storage unit 33 is a memory etc. that stores the wear amount estimation model which is a learned model. When a request for the wear amount estimation model is made by the wear amount estimation device 4, the output unit 34 outputs the wear amount estimation model stored in the storage unit 33, to the wear amount estimation device 4. The data acquisition unit 31 receives the request of the wear amount estimation device 4 for the wear amount estimation model and notifies the output unit 34 of the request.

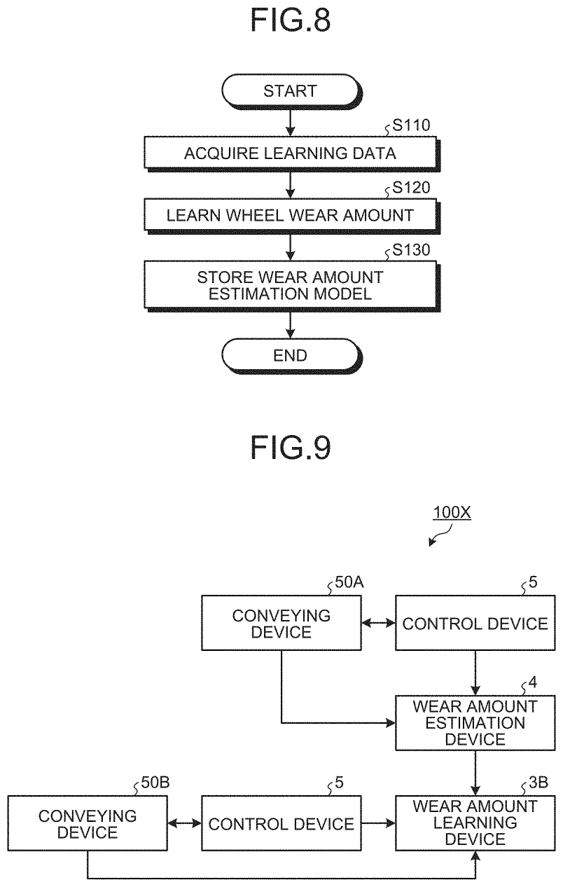

FIG. 8 is a flowchart illustrating a generation processing procedure of a wear amount estimation model by the wear amount learning device according to the embodiment. In controlling the conveying device 50B, the control device 5 acquires the scale FB information 51 and the current FB information 52 from the conveying device 50B. The control device 5 transmits, to the wear amount learning device 3B, the position FB information and the speed FB information obtained from the acquired scale FB information 51, and the current FB information 52. In addition, the control device 5, to the wear amount learning device 3B, transmits the position command information which is information on a command of the position of the mover 1.

The data acquisition unit 31 of the wear amount learning device 3B acquires, from the control device 5, the state information 60. The state information 60 includes the position command information, the position FB information, the speed command information, and the speed FB information which are pieces of information on the position and the speed, and the current FB information 52 which is information on the control current. In addition, the detect acquisition unit 31 acquires the distance information 54 from the conveying device 50B. That is, the wear amount learning device 3B acquires learning data 55B including the state information 60 and the distance information 54, from the control device 5 and the conveying device 50B (step S110).

The machine learning unit 32B learns the wheel wear amount, using the learning data 55B (step S120), Consequently, the machine learning unit 32B generates a wear amount estimation model. The storage unit 33 stores the wear amount estimation model (step S13).

When the wear amount estimation device 4 transmits a request for the wear amount estimation model to the wear amount learning device 3, the data acquisition unit 31 receives the request for the wear amount estimation model and notifies the output unit 34 of the request. Consequently, the output unit 34 outputs the wear amount estimation model stored in the storage unit 33, to the wear amount estimation device 4. The data acquisition unit 41 of the wear amount estimation device 4 receives the wear amount estimation model and stores the wear amount estimation model in the storage unit 43.

When the current-thrust characteristic changes with an increase in the wheel wear amount, the thrust output for the same current increases. As a result, a change in a response of the conveying device 50B as feedback to the same output of the control device 5 increases, such that a gain from the output of the control to the feedback increases. Accordingly, a difference between a command of the position or the speed at a time of acceleration and the feedback may be reduced. Alternatively, the feedback relative to a corner of a waveform of the command of the position or the speed at a time of transition from acceleration to constant speed may become less gentle and round. The wear amount learning device 3B learns so as to estimate the wheel wear amount on the basis of such a change in a feedback operation relative to the command of the position or the speed.

In addition, when the current-thrust characteristic changes with an increase in the wheel wear amount, the thrust output for the same current increases. As a result, the acceleration generated for the same current varies. In view of this, in order to effectively learn the wheel wear amount, the wear amount learning device 3B may calculate the acceleration from the information on the position or the speed and include the calculated acceleration in the learning data 55B. In that case, the wear amount learning device 3B learns the wheel wear amount on the basis of a change in the acceleration of the conveying device 50B caused by a change in a drive current depending on speed feedback of the mover 1, and generates a wear amount estimation model. The wear amount estimation device 4 may calculate the acceleration from the information on the position or the speed, include the calculated acceleration in the estimation data 53, input the calculated acceleration to the wear amount estimation model, and estimate the wheel wear amount on the basis of the change in the acceleration of the conveying device 50B caused by the change in the drive current depending on the speed feedback of the mover 1.

The wear amount monitoring system may include the wear amount learning device 3B and the wear amount estimation device 4. FIG. 9 is a diagram illustrating a configuration of a wear amount monitoring system including the wear amount learning device and the wear amount estimation device according to the embodiment. FIG. 9 illustrates a configuration of a wear amount monitoring system 100X including the wear amount learning device 3B and the wear amount estimation device 4.

The wear amount monitoring system 100X includes the conveying devices 50A and 50B, two control devices 5, the wear amount learning device 3B, and the wear amount estimation device 4. A first one of the two control devices 5 is the control device 5 described with reference to FIG. 1, and is connected to the conveying device 50A and the wear amount estimation device 4. A second one of the two control devices 5 is the control device 5 described with reference to FIG. 7, and is connected to the conveying device 50B and the wear amount learning device 3B. The wear amount estimation device 4 and the wear amount learning device 3B are connected to each other.

The wear amount learning device 3B acquires the learning data 55B by acquiring data from the second control device 5 and the conveying device 50B, and generates a wear amount estimation model. The wear amount estimation device 4 acquires the wear amount estimation model from the wear amount learning device 3B. The wear amount estimation device 4 may acquire the wear amount estimation model from the wear amount learning device 3B by communication or may acquire the wear amount estimation model from the wear amount learning device 3B via a portable storage medium.

The wear amount estimation device 4 acquires the estimation data 53 by acquiring data from the first control device 5 and the conveying device 50A. The wear amount estimation device 4 estimates the amount of wear on the mover wheels 13 of the conveying device 50A on the basis of the wear amount estimation model and the estimation data

In the wear amount monitoring system 100X, the data acquisition unit 31 of the wear amount learning device 3B is a first data acquisition unit, and the data acquisition unit 41 of the wear amount estimation device 4 is a second data acquisition unit.

In the wear amount monitoring system 100X, the first control device 5 and the second control device 5 may be integrated into one control device 5. In that case, one control device 5 controls the conveying devices 50A and 50B.

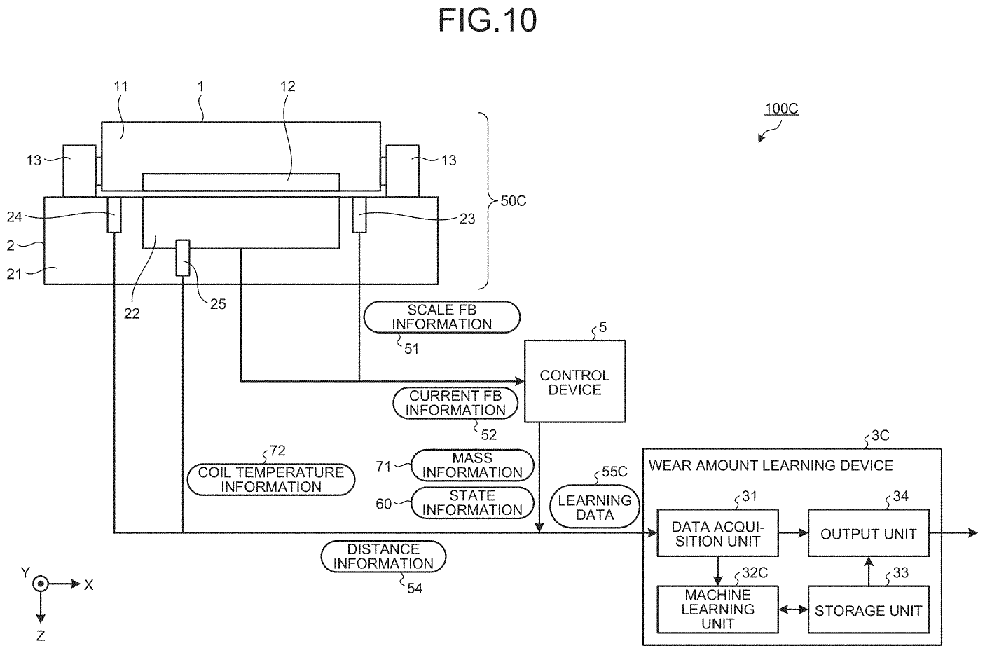

FIG. 10 is a diagram illustrating another configuration of a wear amount monitoring system including a wear amount learning device according to the embodiment. Regarding components among components in FIG. 10 that achieve the same functions as those of the wear amount monitoring systems 100A and 100B, the same reference signs are assigned thereto, and repetitive descriptions thereof will be omitted.

Similarly to the wear amount monitoring system 100B, a wear amount monitoring system 100C is a system that generates a wear amount estimation model. A conveying device 50C is a device similar to the conveying devices 50A and 50B.

In FIG. 10, two axes in a plane parallel to an upper surface of the conveying device 50C, the two axes being orthogonal to each other, are defined as an X axis and a Y axis. An axis orthogonal to the X axis and the Y axis is defined as a Z axis. The Z axis is, for example, an axis parallel to the vertical direction. FIG. 10 illustrates an example where the conveying device 50C moves along a Y-axis direction, but the conveying device 50C may move in any direction.

The wear amount monitoring system 100C includes the conveying device 50C, the control device 5, and a wear amount learning device 3C. The conveying device 50C includes a temperature sensor 25 in addition to the components included in the conveying device 50B. The temperature sensor 25 is disposed on the stator 2.

The temperature sensor 25 is a sensor that detects a temperature of the coil of the linear motor armature 22, and is disposed in the vicinity of the linear motor armature 22. The temperature sensor 25 transmits the detected temperature as coil temperature information 72 to the wear amount learning device 3C. The distance sensor 24 transmits the distance information 54 to the wear amount learning device 3C.

The control device 5 acquires, from the conveying device 50C, the position FB information and the speed FB information obtained from the scale FB information 51, and the current FB information 52, and transmits these pieces of information as information on the position and the speed and information on the control current, to the wear amount learning device 3C. In addition, the control device 5 transmits position command information which is a command of the position of the mover 1 and speed command information which is a derivative thereof to the wear amount learning device 3C. Furthermore, the control device 5 transmits information on a loading mass of the mover 1 to the wear amount learning device 3C. The information on a loading mass of the mover 1 is defined as mass information 71. The mass information 71 is information on the mass obtained by adding the mass of the mover 1 itself and the mass of an object loaded on the mover 1. That is, the mass information 71 is information on the weight applied to the mover wheels 13.

The wear amount learning device 3C is a computer that generates a wear amount estimation model for estimating a wheel wear amount which is the amount of wear on the mover wheels 13. The wear amount learning device 3C acquires, from the control device 5, the state information 60 indicating the state of the conveying device 50C, i.e., the current FB information 52 which is information on the control current, and the position command information, the position FB information, the speed command information, and the speed FB information which are pieces of information on the position and the speed. In addition, the wear amount learning device 30 acquires the mass information 71 from the control device 5.

Furthermore, the wear amount learning device 3C acquires the distance information 54 and the coil temperature information 72 from the conveying device 50C. The mass information 71 and the coil temperature information 72 may be used as the learning data 55C or may be used to correct the feedback information. A description is herein made as to an example where the mass information 71 and the coil temperature information 72 are used as the learning data 55C.

The wear amount learning device 30 acquires the learning data 55C including the state information 60, the mass information 71, the distance information 54, and the coil temperature information 72 from the control device 5 and the conveying device 50C. The wear amount learning device 30 includes the data acquisition unit 31, a machine learning unit 320, the storage unit 33, and the output unit 34.

The machine learning unit 32C learns the wheel wear amount on the basis of the learning data 55C and generates a wear amount estimation model. A description is made herein as to an example where the machine learning unit 320 uses the mass information 71 and the coil temperature information 72 for correction of the feedback information.

The current FB information 52 which is a feedback value of the control current directed to the conveying device 50C varies depending on the loading mass of the mover 1 and the temperature of the coil of the linear motor armature 22. The machine learning unit 32C therefore corrects the scale FB information 51 and the current FB information 52 on the basis of the mass information 71 and the coil temperature information 72 measured in at least one speed pattern. That is, the machine learning unit 32C uses the scale FB information 51 and the current FB information 52 for an advance process on the learning data in a preceding stage of a machine learning process. The machine learning unit 32C machine-learns the wheel wear amount, using the corrected scale FB information 51 and current FB information 52 to generate a wear amount estimation model.

A description is herein made as to an example where the machine learning unit 32C generates a wear amount estimation model accommodating a change in the coil temperature, neither using the coil temperature information 72 as the learning data 55C nor using the coil temperature information 72 for correction of the feedback information

To operate the conveying device 50C continuously, the control device 5 operates the conveying device, for example, in an operation pattern having a repeated speed pattern with acceleration and deceleration illustrated in FIG. 3. A current flows during the acceleration period, the constant speed period, and the deceleration period, such that the linear motor generates heat and thus increasers in temperature. A current hardly flows during the stop period, such that the linear motor dissipates heat and thus decreases in temperature. When these processes are repeated at a high frequency and the linear motor continuously operates, the temperature of the linear motor converges to a certain average temperature at which heat generation and heat dissipation are balanced with each other. This temperature is defined as a high-frequency temperature.

Assume that the operation pattern is a low-frequency operation pattern in which the acceleration period, the constant speed period, and the deceleration period have the same length and the stop period is long. In this case, when the conveying device 50C is continuously operated, the temperature converges to a low-frequency temperature lower than the high-frequency temperature.

A difference in temperature of the linear motor results in a change in the current-thrust characteristic, which affects the estimation of the wheel wear amount. Information on the position or the speed enables the wear amount learning device 3C to identify in what operation pattern the conveying device 50C is operated. For this reason, the wear amount learning device 3C acquires the learning data 55C including the information on the position or the speed in a plurality of operation patterns having different values of the coil temperature. Consequently, the wear amount learning device 3C can identify a wheel wear amount under an operation situation. For example, the wear amount learning device 3C can identify a wheel wear amount in the operation in which the coil temperature increases. Alternatively, the wear amount learning device 3C can identify a wheel wear amount in the operation in which the coil temperature decreases. In other words, the wear amount learning device 3C can learn the wear amount estimation model capable of estimating a wheel wear amount corresponding to a difference in the coil temperature.

As described above, the data acquisition unit 31 acquires, as the learning data 55C, the information on the control current, the information on the position or the speed, and the distance information 54 between the mover 1 and the stator 2 in the plurality of operation patterns having different values of the coil temperature. On the basis of the learning data 55C in the plurality of operation patterns having different values of the coil temperature, the machine learning unit 32C generates a wear amount estimation model for estimating a wheel wear amount from the information on the control current and the information on the position or the speed.

Consequently, the wear amount learning device 3C can generate, from the information on the position or the speed, the wear amount estimation model for estimating a wheel wear amount depending on a change in the coil temperature during the operation of the conveying device 50C, without inputting the information on the coil temperature. In addition, the use of such a wear amount estimation model enables the wear amount learning device 3C to estimate, from the information on the position or the speed, a wear amount corresponding to a change in the coil temperature during the operation of the conveying device 50C, without inputting the information on the coil temperature. With a simple configuration without the temperature sensor 25, therefore, the wear amount learning device 3C can accurately estimate a wheel wear amount, accommodating a change in the coil temperature as well.

In a steady operation of the conveying device 50C, in most cases, the conveying device 50C repeatedly convey the same objects. Before the start or the operation or the conveying device 50C, the total mass of the mover 1 and the object is measured. In view of this, the mass information 71, which is information on the mass of the mover 1, is the measured total mass. The wear amount learning device 3C stores the measured total mass as the mass information 71 in the storage unit 33. The wear amount estimation device 4 may call the mass information 71 in the storage unit 33 and use the mass information 71 for correcting the estimation data 53.

The total mass of the mover 1 and the object to be conveyed is measured moving the mover 1 having the object loaded thereon in a speed pattern with acceleration and deceleration when the wheel wear amount is known and the current-thrust characteristic is known. In that case, the wear amount learning device 3C acquires the information on the control current and information on position feedback, calculates a thrust from the information on the control current, and differentiates the information on the position twice, thereby calculating acceleration. The wear amount learning device 3C calculates the mass information 71 by dividing the calculated thrust by the calculated acceleration.

Consequently, the wear amount learning device 3C can accurately estimate a wheel wear amount with a simple configuration that does not require acquisition of the mass information 71 through a sensor or the like during the operation of the wear amount learning device 3C. The mass information 71 may be calculated by a device other than the wear amount learning device 3C.

The wear amount learning device 3B may be built in the conveying device 50B or may be configured as a device separate from the conveying device 50B as illustrated in FIG. 7. Similarly, the wear amount learning device 3C may be built in the conveying device 50C or may be configured as a device separate from the conveying device 50C as illustrated in FIG. 10. The wear amount learning devices 3B and 3C may exist on a cloud server.

Since the wear amount learning device 3C generates the wear amount estimation model through a processing procedure similar to that of the wear amount learning device 3B, the description thereof will be omitted. A machine learning process performed by the machine learning units 32B and 32C will be described. Since the machine learning process performed by the machine learning unit 32E and the machine learning process performed by the machine learning unit 32C are similar processes, the machine learning process performed by the machine learning unit 32B will be described herein.

The machine learning unit 32B learns a wheel wear amount through so-called supervised learning in accordance with, for example, a neural network model. Supervised learning is a model that gives a learning device a large number of sets of data on a certain input and a result (label), and allows the learning device to learn characteristics of the datasets for estimating results from inputs.

A neural network includes an input layer including plurality of neurons, an intermediate layer (hidden layer) including a plurality of neurons, and an output layer including a plurality of neurons. The intermediate layer may be one layer or two or more layers.

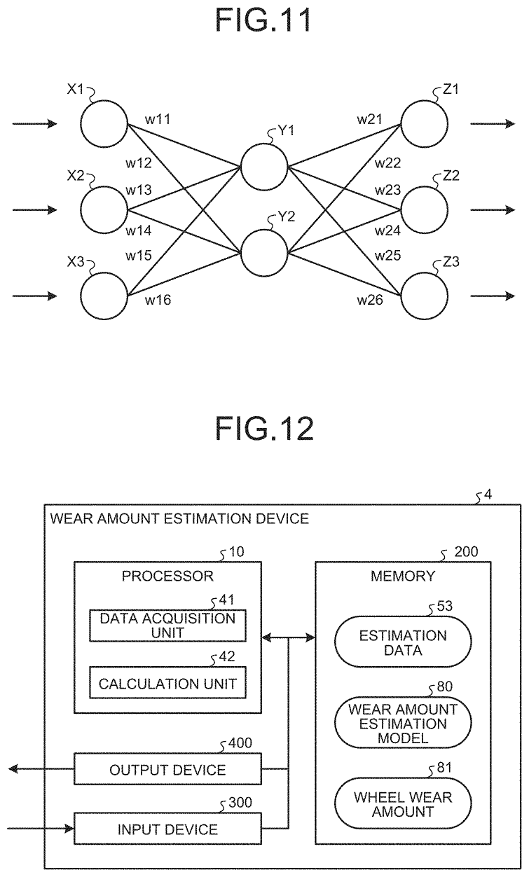

FIG. 11 is a diagram illustrating a configuration of a neural network used by the wear amount learning device according to the embodiment. For a three-layer neural network as illustrated in FIG. 11, a plurality of inputs are input to input layers X1 to X3, and the values of these inputs are multiplied by weights w11 to w16. The results of the multiplication are input to intermediate layers Y1 and Y2, and are multiplied by weights w21 to w26 and output from output layers Z1 to Z3. The output results vary depending on values of the weights w11 to w16 and the weights w21 to w26.

The neural network of the embodiment learns the wheel wear amount through so-called supervised learning in accordance with datasets each created on the basis of a combination of the state information 60 and the distance information 54. That is, the neural network learns the wheel wear amount by adjusting the weights w11 to w16 and the weights w21 to w26 so that results output from the output layers Z1 to Z3 approach the distance information 54 corresponding to the wheel wear amount when the current FB information 52 which is the information on the control current, and the position command information, the position FB information, the speed command information, and the speed FF information on the mover 1 are input to the input layers X1 to X3. The machine learning unit 325 stores, in the storage unit 33, the neural network including the adjusted weights w11 to w16 and w21 to w26. The neural network generated by the machine learning unit 32B is a wear amount estimation model.

The neural network can also learn the wheel wear amount through so-called unsupervised learning. Unsupervised learning is a method that gives the wear amount learning device 3B a large amount of input data alone and allows the wear amount learning device 3B to learn how the input data are distributed, and learn, without corresponding teaching output data being given, a device that performs compression, classification, shaping, and the like on the input data. Unsupervised learning provides, for example, a cluster of similar features in the datasets. Using this result, unsupervised learning sets some criterion and assigns outputs that optimizes the criterion, thereby achieving prediction of the outputs. In addition, there is what is called semi-supervised learning as a type of problem setting intermediate between unsupervised learning and supervised learning. Semi-supervised learning is a learning method that uses data a part of which is sets of data on inputs and outputs exist, the rest or the data being data on inputs alone.

The machine learning unit 32B may learn the wheel wear amount in accordance with datasets created for a plurality of conveying devices 50B. The machine learning unit 32B may acquire the datasets from the separate conveying devices 50B used in the same site, or may learn the wheel wear amount, using the datasets collected from the plurality of conveying devices 50B operating independently in different sites. Furthermore, in the middle of the learning, the wear amount learning device 3B can add the conveying device 50B as a target from which the datasets are collected, or conversely, can exclude the conveying device 50B from such targets. In addition, the wear amount learning device 3B that has learned a wheel wear amount for a certain conveying device may be attached to another conveying device, and the attached wear amount learning device 3B may relearn and update the wheel wear amount for the other conveying device.

As a learning algorithm used in the machine learning unit 32B, deep learning that learns extraction of feature quantities themselves can be used, and the machine learning unit 32B may perform machine learning in accordance with another known method, for example, genetic programming, functional logic programming, or a support vector machine.

Hardware configurations of the wear amount estimation device 4 and the wear amount learning devices 3B and 3C will be described. Since the wear amount estimation device 4 and the wear amount learning devices 3B and 3C have similar hardware configurations, the hardware configuration of the wear amount estimation device 4 will be described here.

FIG. 12 is a diagram illustrating an example hardware configuration that implements the wear amount estimation device according to the embodiment. The wear amount estimation device 4 can be implemented by an input device 300, a processor 10, a memory 200, and an output device 400. Examples of the processor 10 include a central processing unit (CPU, also referred to as a processing device, an arithmetic device, a microprocessor, a microcomputer, or a digital signal processor (DSP)), and system large scale integration (LSI). Examples of the memory 200 include a random access memory (RAM) and a read only memory (ROM).

The wear amount estimation device 4 is implemented by the processor 10 reading and executing a computer-executable wear amount estimation program stored in the memory 200 for performing an operation of the wear amount estimation device 4. It can also be said that the wear amount estimation program which is a program for performing the operation of the wear amount estimation device 4 causes a computer to execute a procedure or a method of the wear amount estimation device 4.

The wear amount estimation program executed by the wear amount estimation device 4 has a modular configuration including the data acquisition unit 41 and the calculation unit 42, and these are loaded on a main storage device and generated on the main storage device.

The input device 300 receives and transmits the estimation data 53 and a wear amount estimation model 80 to the data, acquisition unit 41. The wear amount estimation model 80 is a wear amount estimation model generated by the wear amount learning device 3B described with reference to FIG. 7.

The memory 200 is used as a temporary memory when the processor 10 executes various processes. In addition, the memory 200 stores the estimation data 53, the wear amount estimation model 80, and a wheel wear amount 81. The wheel wear amount 81 is a wheel wear amount calculated by the calculation unit 42 using the estimation data 53 and the wear amount estimation model 80. The output device 400 outputs the wheel wear amount 81 to the control device 5.

The wear amount estimation program may be stored in a computer-readable storage medium as a file in an installable format or an executable format and provided as a computer program product. The wear amount estimation program may be provided to the wear amount estimation device 4 via a network such as the Internet. A part of the functions of the wear amount estimation device 4 may be implemented by dedicated hardware such as a dedicated circuit, and another part thereof may be implemented by software or firmware.

As described above, the wear amount estimation device 4 according to the embodiment acquires, as the estimation data 53, the information on the control current flowing through the linear motor in order to drive and control the mover 1 of the conveying device 50A, and the information on the controlled position or speed of the driven mover 1. Then, the wear amount estimation device 4 estimates the amount of wear by inputting the estimation data 53 to the wear amount estimation model 80 for estimating the amount of wear on the mover wheels 13. Consequently, the wear amount estimation device 4 can estimate the amount of wear on the mover wheels 13 with a simple configuration.

In addition, the wear amount learning device 3B according to the embodiment acquires, as the learning data 55B, the information on the control current flowing through the linear motor in order to drive and control the mover 1 of the conveying device 50B, the information on the controlled position or speed of the driven mover 1, and the distance information 54 indicating a distance between the mover 1 and the stator 2 of the linear motor. Then, the wear amount learning device 3B generates, on the basis of the learning data 55B a wear amount estimation model for estimating the amount of wear on the mover wheels 13. Consequently, the wear amount learning device 3B can generate a wear amount estimation model capable of estimating the amount of wear on the mover wheels 13 with a simple configuration.

The configurations described in the embodiment above are merely examples and can be combined with other known technology and part of the configurations can be omitted or modified without departing from the gist thereof.

### REFERENCE SIGNS LIST

1 mover; 2 stator; 3B, 3C wear amount learning device; 4 wear amount estimation device; 5 control device; 10 processor; 11 mover housing; 12 linear motor magnet; 13 mover wheel; 21 stator housing; 22 linear motor armature; 23 scale head; 24 distance sensor; 25 temperature sensor; 31, 41 data acquisition unit; 32B, 32C machine learning unit; 33, 43 storage unit; 4, 44 output unit; 42 calculation unit; 50A to 50C conveying device; 51 scale FB information; 52 current FB information; 53 estimation data; 54 distance information; 55B, 55C learning data; 60 state information; 61 estimation result; 71 mass information; 72 coil temperature information; 80 wear amount estimation model; 31 wheel wear amount; 100A to 100C, 100X wear amount monitoring system; 200 memory; 300 input device; 400 output device; X1 to X3 input layer; Y1, Y2 intermediate layer; Z1 to Z3 output layer; w11 to w16, w21 to w26 weight.

1. A wear amount estimation device to estimate an amount of wear on a wheel of a conveying device having a mover movable by a wheel-type guide mechanism, the mover being driven and controlled by a linear motor, the wear amount estimation device comprising:
data acquisition circuitry to acquire, as estimation data, information on a control current flowing through the linear motor in order to drive and control the mover and information on a controlled position or speed of the driven mover;
storage circuitry to store a wear amount estimation model for estimating the amount of wear; and
calculation circuitry to estimate the amount of wear by inputting the estimation data to the wear amount estimation model.

2. The wear amount estimation device according to claim 1, wherein the calculation circuitry estimates the amount of wear on a basis of the information on the control current and acceleration calculated from the information on the position or speed.

3. The wear amount estimation device according to claim 1, wherein the wear amount estimation model is generated by learning of the amount of wear based on the estimation data.

4. The wear amount estimation device according to claim 1, wherein
the calculation circuitry estimates the amount of wear on a basis of information regarding a temperature of a coil of a stator or mass information that is information on a mass of the mover to be driven and controlled.

5. A wear amount learning device to generate a wear amount estimation model for estimating an amount of wear on a wheel of a conveying device having a mover movable by a wheel-type guide mechanism, the mover being driven and controlled by a linear motor, the wear amount learning device comprising:
data acquisition circuitry to acquire, as learning data, information on a control current flowing through the linear motor in order to drive and control the mover, information on a controlled position or speed of the driven mover, and distance information indicating a distance between the mover and the stator; and
machine learning circuitry to generate, on a basis of the learning data, a wear amount estimation model for estimating the amount of wear, from the information on the control current and the information on the position or speed.

6. The wear amount learning device according to claim 5, wherein
the data acquisition circuitry further acquires a coil temperature that is a temperature of a coil of the linear motor, and mass information that is information on a mass of the mover to be driven and controlled, and
the machine learning circuitry corrects learning data including the information on the control current and the information on the position or speed, on a basis of the coil temperature and the mass information, and generates the wear amount estimation model on a basis of the corrected learning data.

7. The wear amount learning device according to claim 5, wherein
the data acquisition circuitry further acquires a coil temperature that is a temperature of a coil of the linear motor, and mass information that is information on a mass of the mover to be driven and controlled, and
the machine learning circuitry generates the wear amount estimation model, with the coil temperature and the mass information included in the learning data.

8. A wear amount monitoring system to estimate an amount of wear on a wheel of a conveying device having a mover movable by a wheel-type guide mechanism, the mover being driven and controlled by a linear motor, the wear amount monitoring system comprising:
a wear amount learning device to generate a wear amount estimation model for estimating the amount of wear; and
a wear amount estimation device to estimate the amount of wear, using the wear amount estimation model, wherein
the wear amount learning device includes:
first data acquisition circuitry to acquire, as learning data, information on a control current flowing through the linear motor in order to drive and control the mover, information on a controlled position or speed of the driven mover, and distance information indicating a distance between the mover and the stator; and
machine learning circuitry to generate, on a basis of the learning data, a wear amount estimation model for estimating the amount of wear from the information on the control current and the information on the position or speed, and
the wear amount estimation device includes:
second data acquisition circuitry to acquire, as estimation data, the information on the control current and the information on the position or speed;
storage circuitry to store the wear amount estimation model generated by the wear amount learning device; and
calculation circuitry to estimate the amount of wear by inputting the estimation data to the wear amount estimation model.

9. The wear amount monitoring system according to claim 8, further comprising:
the conveying device; and
control circuitry to control the conveying device, wherein
the conveying device includes a scale head (23),
the control circuitry acquires the information on the position as scale FB information from the scale head of the conveying device, and transmits the scale information to the second data acquisition circuitry,
the information on the control current is information which the control circuitry acquires as current FB information from a current output to the linear motor for feedback control of the conveying device, and
the control circuitry transmits the current FB information to the second data acquisition circuitry.
